(19) United States
(12) Patent Application Publication
(10) Pub. No.: US 2010/0161691 A1
(43) Pub. Date: Jun. 24, 2010

(54) METHOD FOR PROVIDING A PORTABLE SOFTWARE COMPUTING ENVIRONMENT FOR A LOW-SPEED PORTABLE STORAGE DEVICE, AND PORTABLE STORAGE DEVICE

(75) Inventors: WON YOUNG KIM, DAEJEON (KR); KYOUNG I KU, SEOUL (KR); MOON YOUNG CHUNG, DAEJEON (KR); WAN CHOI, DAEJEON (KR)

Correspondence Address: AMPACC Law Group, 3500 188th Street S.W., Suite 103, Lynnwood, WA, 98037, US

(73) Assignee: ELECTRONICS AND TELECOMMUNICATIONS RESEARCH INSTITUTE, DAEJEON (KR)

(21) Appl. No.: 12/615,369

(22) Filed: Nov. 10, 2009

(30) Foreign Application Priority Data
Dec. 22, 2008 (KR) 10-2008-0131751

(51) Int. Cl. G06F 17/30

(52) U.S. Cl. 707/824; 707/E17.01

(57) ABSTRACT

Provided are a method for providing a portable software computing environment and a portable storage device, which connect a computing environment in a low-speed portable storage device to a computer to provide it to a user. A portable software computing environment is changed into a file image to store the changed file image in a portable storage device. The file image of the portable storage device is copied in the storage of a host computer. An input/output request of an application operating in the portable software computing environment is intercepted, and a file is read from the file image copied in the storage of the host computer or a file is written in the copied file image. Changed information which is temporarily stored is reflected in the file image.

### CROSS-REFERENCE TO RELATED APPLICATIONS

This application claims priority under 35 U.S.C. §119 to Korean Patent Application No. 10-2008-0131751, filed on Dec. 22, 2008, in the Korean Intellectual Property Office, the disclosure of which is incorporated herein by reference in its entirety.

### TECHNICAL FIELD

The following disclosure relates to a method for providing a portable software computing environment and a portable storage device, and in particular, to a method for providing a portable software computing environment and a portable storage device providing a user with a computing environment in a low-speed portable storage device by connecting the low-speed portable storage device with a computer.

### BACKGROUND

Portable storage devices such as flash memories, in spite of their convenient mobility, are not suitable for a computing task that generates many inputs/outputs (Is/Os), due to their low-speed performance. Consequently, flash memories are recognized as secondary storage devices for simple transfer of data instead of as storage devices that store computing environments in order to provide portable service.

FIG. 1 is a block diagram illustrating a software (SW) computing environment in a portable storage device.

Referring to FIG. 1, when a portable storage device 110 is connected to a computer 120, a portable SW) computing environment 130 may be driven automatically or manually. Accordingly, if a user has the portable storage device 110, the user uses the same software computing environment at all times and locations.

When intending to store a user's computing environment in a portable storage device, the performance of portable storage device must be considered, unlike when a file is simply copied. There is no pronounced difference between a high-speed portable storage device and a low-speed portable storage device when one large file is accessed. When a plurality of files are continuously accessed, however, the difference in performance between them is prominent. Although different depending on case, a computing environment that exceeds a certain scale accesses at least hundreds to thousands of files. Accordingly, even a computing environment that has no performance limitations when executed in a high-speed portable storage device, will have speed limitations in a low-speed portable storage device. That is, in a low-speed portable storage device, the initial driving time of a computing environment is prolonged, and function performing time in the environment is also prolonged.

It is possible to copy a computing environment stored in a portable storage device to a host computer and to use the environment. However, more time is taken in copying hundreds of files from a low-speed portable storage device to the hard disk of the host computer.

### SUMMARY

In one general aspect of the present invention, a method for providing a portable software computing environment for low-speed portable storage device includes: changing a portable software computing environment into a file image to store the changed file image in a portable storage device; and copying the file image of the portable storage device in a storage of a host computer, intercepting an input/output request of an application operating in the portable software computing environment, and reading a file from the file image copied or writing a file in the copied file image in the storage of the host computer; and reflecting changed information, which is temporarily stored in the storage of the host computer, on the file image of the portable storage device when a certain time elapses or updated data exceed a certain capacity.

In another general aspect, a method for providing a portable software computing environment for low-speed portable storage device includes: reflecting changed information, which is not yet reflected on a file image of a portable storage device and is temporarily stored, on the file image; deleting a copied file image in a storage of a host computer; and terminating driving of the portable storage device.

In another general aspect, a portable storage device in a system for providing software computing environment for low-speed portable storage device includes: a file management engine copying a file image comprising a changed form of portable software computing environment in a storage of a host computer; and a driver driven by the file management engine to provide an input/output for the file image, in the portable software computing environment.

Other features and aspects will be apparent from the following detailed description, the drawings, and the claims.

### BRIEF DESCRIPTION OF THE DRAWINGS

FIG. 1 is a block diagram illustrating the environment of a user using a software (SW) computing environment in a portable storage device.

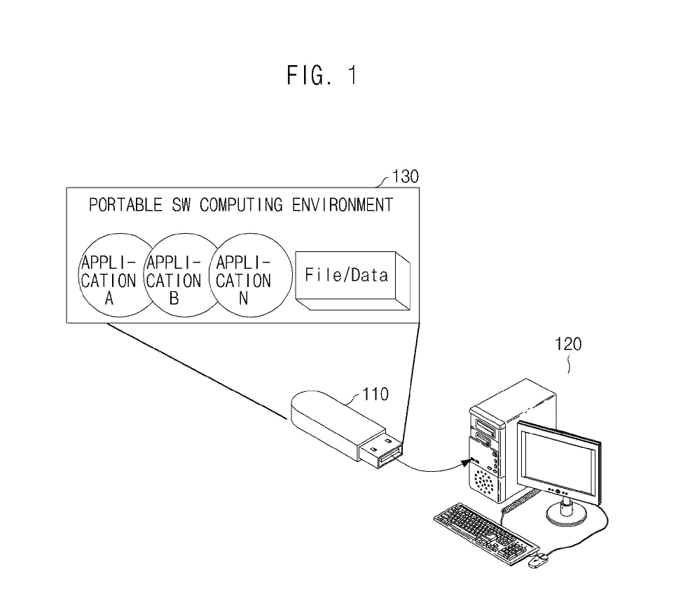

FIG. 2 is a block diagram of a system for providing a portable software computing environment for low-speed portable storage device according to an exemplary embodiment.

FIG. 3 is a flowchart illustrating a method for driving portable storage device in the system for providing a portable software computing environment according to an exemplary embodiment.

FIG. 4 is a flowchart illustrating a process which is performed when disconnecting the portable storage device in the system for providing a portable software computing environment according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

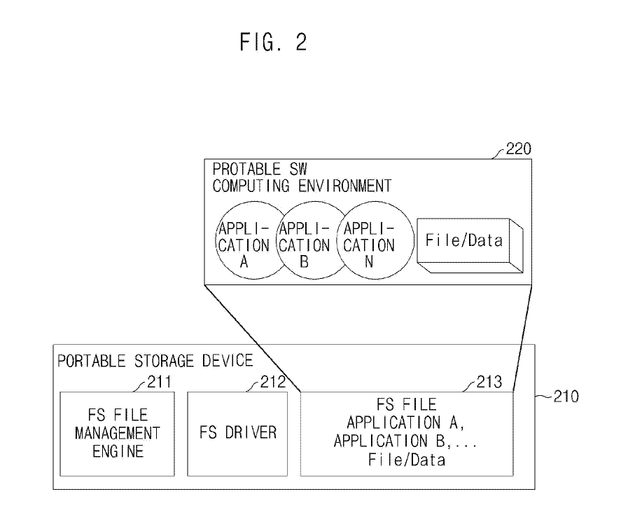

FIG. 2 is a block diagram of a system for providing a portable software computing environment for low-speed portable storage device according to an exemplary embodiment of the present invention.

Referring to FIG. 2, a portable storage device 210 in a system for providing a portable software computing environment according to an exemplary embodiment includes a file image 213 (hereinafter, referred to as “a File System (FS) file”), an FS file management engine 211, and an FS driver 212.

The FS file management engine 211 performs the driving and ending operations of a portable software (SW) computing environment 220.

The FS driver 212 performs works for actual inputs/outputs according to the access of a user in the portable SW computing environment 220.

The FS file 213 has a changed form of portable SW computing environment.

The form of the FS file 213 is similar to a disk image file. The disk image file is generally used as the storing space of an operating system (OS) image data which are driven on a virtual machine. There are the VPC format of a Virtual PC, the VMDK format of VMWare and the QCOW format of QEMU as disk image file formats having the OS image data.

Since the FS file 213 has a structure similar to that of the disk image file, the entire size of the FS file 213 may be changed when data are added or deleted in the FS file 213, and the compression or encryption function of data may be provided.

The difference between the FS file 213 and the disk image file is that the FS file 213 stores necessary information in a portable platform only instead of an entire OS image file used in the virtual machine.

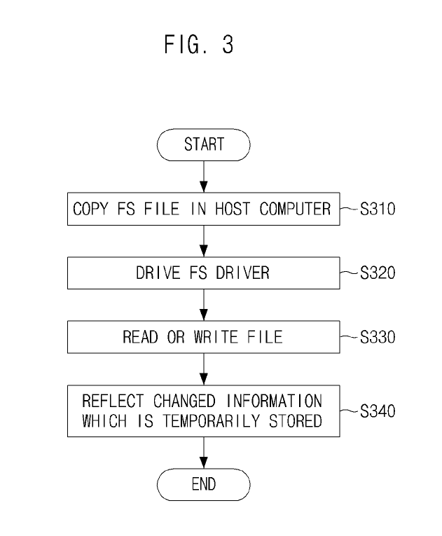

FIG. 3 is a flowchart illustrating a method for driving portable storage device in the system for providing a portable software computing environment according to an exemplary embodiment. That is, FIG. 3 illustrates a process which is performed according to the driving of the FS file management engine 211 after connecting the portable storage device 210 to a computer (not shown).

First, a portable software computing environment is changed into an FS file, and the changed file is stored in a portable storage device. Next, as illustrated in FIG. 3, the FS file management engine 211 copies the FS file 213 in the storage of a host computer (not shown) in operation 5310. Subsequently, the FS file management engine 211 drives the FS driver 212 providing inputs/outputs (Is/Os) for the FS file 213 in operation 5320.

When the FS driver 212 is driven, the FS file copied in the storage of the host computer is recognized to a user as a file identical to that of the portable SW computing environment 220 instead of being recognized as an arbitrary file. At this point, the user may use a plurality of applications in the FS file 213 as they are.

When the user executes the application in the portable SW computing environment 220, the FS driver 212 generates an input/output (I/O) request to a file necessary for the execution of a corresponding application. At this point, the FS driver 220 intercepts the input/output (I/O) request of the application operating in the portable SW computing environment 220, and reads a file from the FS file 213 copied or writes a file in the copied FS file 213 in the storage of the host computer in operation 5330. Accordingly, the FS driver 220 processes inputs/outputs (Is/Os) with the almost same performance as an input/output (I/O) process for a file stored in the storage of the host computer. When the generation or change of data occurs, the FS driver 220 temporarily stores changed information in the storage of the host computer.

When a certain time elapses, or updated data exceed a certain capacity, the FS file management engine 211 reflects the changed information, which is temporarily stored in the storage of the host computer, on the FS file 213 of the portable storage device 210 in operation S340.

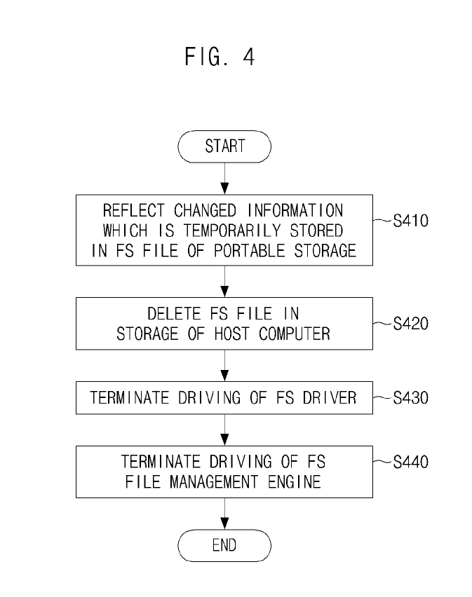

FIG. 4 is a flowchart illustrating a process which is performed when disconnecting the portable storage device in the system for providing a portable software computing environment according to an exemplary embodiment. That is, FIG. 4 illustrates a process which is performed when disconnecting the portable storage device 210 from the computer after the use of the portable SW computing environment.

Referring to FIG. 4, when a user intends to terminate the use of the portable SW computing environment 220, the FS file management engine 211 reflects changed information, which is not yet reflected in the FS file 213 of the portable storage device 210 and is temporarily stored, in the FS file 213 of the portable storage device 210 in operation S410. Then, the FS file management engine 211 deletes a copied FS file in the storage of the host computer in operation S420. The FS file management engine 211 terminates the driving of the FS driver 212 in operation S430, and the driving of the FS file management engine 211 is also terminated in operation S440.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for providing software computing environment for low-speed portable storage device, the method comprising:
changing a portable software computing environment into a file image to store the changed file image in a portable storage device;
copying the file image of the portable storage device in a storage of a host computer;
intercepting an input/output request of an application operating in the portable software computing environment, and reading a file from the file image copied or writing a file in the copied file image in the storage of the host computer; and
reflecting changed information, which is temporarily stored in the storage of the host computer, on the file image of the portable storage device when a certain time elapses or updated data exceed a certain capacity.

2. The method of claim 1, further comprising driving an FS driver of the portable storage device, wherein the FS driver performs the reading or writing of the file.

3. The method of claim 2, wherein the file image copied in the storage of the host computer is recognized as a file identical to a file of the portable software computing environment when the FS driver is driven.

4. The method of claim 2, wherein, when the application in the portable software computing environment is executed, the FS driver generates the input/output request to a file necessary for the execution of the application.

5. The method of claim 1, wherein the copying of the file image of the portable storage device is performed by a file management engine of the portable storage device.

6. The method of claim 2, wherein the FS driver is driven by the file management engine of the portable storage device.

7. The method of claim 1, wherein the reading or writing of the file comprises generating the input/output request to a file necessary for execution of the application when the application in the portable software computing environment is executed.

8. The method of claim 6, wherein the input/output request is generated by the FS driver.

9. The method of claim 1, wherein the reflecting of the changed information on the file image is performed by a file management engine of the portable storage device.

10. A method for providing a portable software computing environment for low-speed portable storage device, the method comprising:
reflecting changed information, which is not yet reflected on a file image of a portable storage device and is temporarily stored, on the file image;
deleting a copied file image in a storage of a host computer; and
terminating driving of the portable storage device.

11. The method of claim 10, wherein the reflecting of the changed information on the file image which is temporarily stored is performed by a file management engine of the portable storage device.

12. The method of claim 10, wherein the deleting of the copied file image is performed by a file management engine of the portable storage device.

13. The method of claim 10, wherein the terminating of the portable storage device comprises:
terminating driving of a driver; and
terminating driving of a file management engine.

14. The method of claim 13, wherein the terminating of the driver is performed by the file management engine.

15. A portable storage device in a system for providing a portable software computing environment for low-speed portable storage device, the portable storage device comprising:
a file management engine copying a file image comprising a changed form of portable software computing environment in a storage of a host computer; and
a driver driven by the file management engine to provide an input/output for the file image, in the portable software computing environment.

16. The portable storage device of claim 15, wherein the file management engine reflects changed information, which is temporarily stored in the storage of the host computer, on the file image when a certain time elapses or updated data exceed a certain capacity.

17. The portable storage device of claim 16, wherein the file management engine reflects changed information, which is not yet reflected in the file image and is temporarily stored, on the file image, deletes a copied file image in the storage of the host computer, terminates driving of the driver, and terminates driving of the file management engine.
